(19) United States
(12) Patent Application Publication
(10) Pub. No.: US 2010/0256939 A1
(43) Pub. Date: Oct. 7, 2010

(54) Heading Error Removal System for Tracking Devices

(75) Inventor: Johann Borenstein, Ann Arbor, MI (US)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: THE REGENTS OF THE UNIVERSITY OF MICHIGAN, Ann Arbor, MI (US)

(21) Appl. No.: 12/418,539

(22) Filed: Apr. 3, 2009

(51) Int. Cl. G01C 25/00; G06F 19/00

(52) U.S. Cl. 702/96

(57) ABSTRACT

Systems are able to reduce or remove slowly-varying drift errors, such as heading errors and rate of rotation errors, to correct the measurements from tracking devices. The systems may be used to remove the slow varying drift errors for gyroscopic tracking device sensors, or other types of sensors used for determining heading, rates of rotation, or position. The systems may be employed in personal dead reckoning systems, or other personnel tracking device, as well as in vehicle tracking devices. The system uses heuristic assumptions to correct for these drift errors, via a feedback loop control having an accumulator responsive to changes in output signals. The accumulator is able to produce a signal that over time compensates for the inherent drift errors on those output signals. In some examples, that feedback loop control can be adjusted to compensate from deviations from those heuristic assumptions, such as swaying, curving, or turning.

### STATEMENT REGARDING FEDERALLY SPONSORED RESEARCH OR DEVELOPMENT

This invention was made with government support under Contract No. No. DE FG52 2004NA25587 awarded by the U.S. Department of Energy. The government has certain rights in the invention.

### BACKGROUND OF THE DISCLOSURE

1. Field of the Disclosure

The disclosure relates generally to personal tracking systems and, more particularly, to reducing or eliminating measurement drift errors in personal tracking systems.

2. Brief Description of Related Technology

While there is increasing interest in GPS (global positioning system)-based tracking systems, for many applications non-GPS tracking is in high demand. GPS is effective for locating and guiding automobiles, cyclists, hikers, photographers, etc. so long as there is sufficient satellite coverage for position triangulation. Non-GPS tracking, while effective in these applications, is also useful where satellite coverage is not available. For example, non-GPS systems have been used to track personnel in indoor environments, where satellite reception is typically limited or non-existent.

While non-GPS systems have better reach in some environments, non-GPS, beacon-free systems are generally considered much less accurate than GPS systems. The latter rely upon highly accurate satellite positioning. The former, however, rely upon gyroscopes (“gyros”) to estimate a user's heading. In operation, a gyro measures a rate of rotation, ω. Often multiple gyros are used to measure angular rates about different axes. As is well known, the measured rate of rotation from a gyro is inherently plagued by signal error, most notably drift. Therefore, when this rate of rotation is numerically integrated over time to produce the desired heading information, the errors can increase substantially and without bound. Small errors in each gyro signal can yield huge errors when trying to determine the actual position of such non-GPS devices.

Gyros are susceptible to a number of different types of error sources. Gyros are temperature sensitive, meaning their output data for the same physical movement may differ in different environments, for example, as a user moves from outside to indoors. Certain types of gyros experience an inherent acceleration non-linearity that introduces signal errors that depend upon how the user is moving during operation of the gyroscopic device. The heading measured for two users both going in the same direction can be dramatically different if one user accelerates at a different rate than another user. These are all slow-varying errors on the angular rate of rotation signal, but they all can result in large errors over time.

While these errors are important, drift is the most difficult slow-varying error to address. At a base level, drift error is inherent to all gyroscopes. Drift is produced when small, near-constant deviations from the correct signal are integrated with respect to time. The highly undesirable result of drift is that the error of the computed heading increases continuously and without bound.

There are two types of drift that can degrade the performance of a gyro: high-frequency drift and a slow-changing, near-DC drift. The slowly-changing, near-DC component is termed “bias instability,” while the high-frequency noise component typically has an average of zero and is termed “Angle Random Walk”—ARW. The high-frequency component creates only relatively small errors in the heading signal, because the average error value on the angular rate of rotation is approximately zero over time. The slowly-varying, near-DC component therefore typically dominates the drift error, as is true of temperature sensitivity error and non-linear acceleration error which are both slow-changing components as well. In fact, in the present application, all three of these slow-varying, near-DC component sources of error are collectively referred when the term “drift” is used herein.

The most common methods for reducing the effects of gyro drift are to integrate inertial navigation system (INS) information and GPS information. See, for example, [Cavallo, F. Sabatini, A. M., and Genovese, V. (2005). “A step toward GPS/INS personal navigation systems: real-time assessment of gait by foot inertial sensing.” Proceedings of the IEEE/RSJ International Conference on Intelligent Robots and Systems (IROS), San Diego, Calif.], [Mohinder S. Grewal, Lawrence R. Weill, Angus P. Andrews, 2002, “Global Positioning Systems, Inertial Navigation, and Integration” Copyright 2001 John Wiley & Sons, Inc.], and [Grejner-Brzezinska, D. A., Toth, C., Moafipoor, S., Jwa, Y., and Kwon, J. (2006). “Multi-sensor personal navigator supported by human motion dynamics model.” Proceedings of the 3rd IAG/12th FIG Symposium, Baden, Austria]. Others integrate gyroscope data with data from a magnetic compass. See, for example, Cho et al. [Cho, S. Y., Lee, K. W., Park, C. G., and Lee, J. G. (2003). “A Personal Navigation System Using Low-Cost MEMS/GPS/Fluxgate.” Proceedings of the 59^{th} Institute of Navigation (ION) Annual Meeting, Albuquerque, N. Mex.]. Others have proposed a method that makes use of available maps and map matching techniques for further enhancement. See, for example, Basnayake, C., Mezentsev, O., Lachapelle, G., and Cannon, M. E. (2005). “An HSGPS, inertial and map-matching integrated portable vehicular navigation system for uninterrupted real-time vehicular navigation.” International Journal of Vehicle Information and Communication Systems, 1, 131-151. The main drawback of these approaches is that either they each require external reference markers or external information of some kind, and that information is required ahead of time. Yet, such information may not always be available, or it may not be accurate or up-to-date.

There have been a few attempts to addressing drift using techniques that do not require external references. Specifically, there have been attempts to find a mathematical model for biasing errors. See, for example, [Paniit, S. M. and Wbiang, Z. (1986). “Modeling Random Gyro Drift Rate by Data Dependent Systems.” IEEE Transactions on Aerospace and Electronic Systems, AES-22, 455-460] and [Chen, X. (2004). “Modeling Temperature Drift of FOG by Improved BP Algorithm and by Gauss-Newton Algorithm.” Lecture Notes in Computer Science—Springer Berlin/Heidelberg]. These techniques, however, have limited applicability and can only estimate the deterministic part of the bias drift, if at all. Either way, more accurate, corrective techniques are needed.

### SUMMARY OF THE DISCLOSURE

In accordance with an example, a tracking device comprises; a sensor assembly to measure rate of rotation and heading for the tracking device; a memory for storing measured rate of rotation and heading data; and a controller to execute computer-executable instructions for removing static drift error from the measured rate of rotation to produce a normalized rate of rotation, wherein the normalized rate of rotation includes a drift error component that varies during operation of the tracking device, integrating the normalized rate of rotation to produce a feedback heading, supplying the feedback heading to a closed loop feedback control that is to perform a low pass filtering on the feedback heading and that is to map the feedback heading onto one of a plurality of dominant directions to form a mapped feedback heading, an accumulator within the closed loop feedback control accumulating error values corresponding to a difference between the mapped feedback heading and a baseline heading, the closed loop feedback control producing an integrator signal that counteracts the effects of the drift error component of the normalized rate of rotation, correcting the normalized rate of rotation by applying the integrator signal to the normalized rate of rotation signal to produce a corrected rate of rotation signal, and integrating the corrected rate of rotation to produce a corrected heading.

In accordance with another example, a method for removing drift error from a tracking device having a sensor assembly to measure rate of rotation and heading for the tracking device comprises: removing static drift error from the measured rate of rotation to produce a normalized rate of rotation, wherein the normalized rate of rotation includes a drift error component that varies during operation of the tracking device; integrating the normalized rate of rotation to produce a feedback heading; supplying the feedback heading to a closed loop feedback control that is to perform a low pass filtering on the feedback heading and that is to map the feedback heading onto one of a plurality of dominant directions to form a mapped feedback heading; an accumulator within the closed loop feedback control accumulating error values corresponding to a difference between the mapped feedback heading and a baseline heading; the closed loop feedback control producing an integrator signal that counteracts the effects of the drift error component of the normalized rate of rotation; correcting the normalized rate of rotation by applying the integrator signal to the normalized rate of rotation signal to produce a corrected rate of rotation signal; and integrating the corrected rate of rotation to produce a corrected heading.

In accordance with yet another example, a tracking device comprises: a sensor assembly to measure rate of rotation and heading for the tracking device; a memory for storing measured rate of rotation and heading data; and a controller to execute computer-executable instructions for removing static drift error from the measured rate of rotation to produce a normalized rate of rotation, wherein the normalized rate of rotation includes a drift error component that varies during operation of the tracking device, applying the normalized rate of rotation to a closed loop feedback control that includes an accumulator for accumulating error values corresponding to a difference between the normalized rate of rotation and a baseline rate of rotation, the closed loop feedback control producing an integrator signal that counteracts the effects of the drift error component of the normalized rate of rotation, and correcting the normalized rate of rotation by applying the integrator signal to the normalized rate of rotation signal to produce a corrected rate of rotation signal.

In accordance with another example, a method for removing drift error from a tracking device having a sensor assembly to measure rate of rotation and heading for the tracking device comprises: removing static drift error from the measured rate of rotation to produce a normalized rate of rotation, wherein the normalized rate of rotation includes a drift error component that varies during operation of the tracking device; applying the normalized rate of rotation to a closed loop feedback control that includes an accumulator for accumulating error values corresponding to a difference between the normalized rate of rotation and a baseline rate of rotation; the closed loop feedback control producing an integrator signal that counteracts the effects of the drift error component of the normalized rate of rotation; and correcting the normalized rate of rotation by applying the integrator signal to the normalized rate of rotation signal to produce a corrected rate of rotation signal.

### BRIEF DESCRIPTION OF THE DRAWING FIGURES

For a more complete understanding of the disclosure, reference should be made to the following detailed description and accompanying drawing figures, in which like reference numerals identify like elements in the figures, and in which:

FIG. 1 is a block diagram of a drift error reduction system using a feedback loop control with a binary accumulator in accordance with an example;

FIG. 2 is a plot of simulated values for the rate of rotation from a gyroscopic tracking device plotted against the accumulated error value from the feedback loop control of FIG. 1;

FIG. 3 is a block diagram of a drift error reduction system using a feedback loop control with a binary accumulator in accordance with another example;

FIGS. 4A-4C illustrative examples of different types of movement for a tracking device, swaying, curving, and turning, respectively;

FIGS. 5A-5C are plots for a simulated walk with a sharp 90-degree turn, where FIG. 5A illustrates the results from a drift error reduction system that uses only a double low pass filter (DLPF), FIG. 5B illustrates the results from a drift error reduction system that uses a DLPF and a controller that includes a repetition rate enhancement; and where FIG. 5C illustrates the results from a drift error reduction system that uses a DLPF, a repetition rate enhancement, and an attenuator gain control enhancement, all in accordance with an example;

FIG. 6 is a block diagram of a drift error reduction system using a feedback loop control with a binary accumulator in accordance with yet another example;

FIG. 7A is an illustration of a plurality of dominant directions overlaying a layout map;

FIG. 7B is a plot of heading angle mapping using a MOD function to simulate the dominant direction heuristic assumption;

FIG. 8 is a block diagram of a process for removing drift error, on the rate of rotation and heading error, for a tracking device;

FIG. 9 is a block diagram of an example implementation a personal dead-reckoning system;

FIG. 10 illustrates a top view of a geographic layout area and illustrates a test walking path engaged using a device equipped with a heuristic drift reduction system in accordance with an example;

FIG. 11 is plot of actual positioning data, against uncorrected position determination, and heuristic drift reduction corrected position determined for the path of FIG. 10;

FIG. 12 illustrates a top view of a geographic layout area and illustrates a test walking path engaged using a device equipped with a heuristic drift elimination system in accordance with an example;

FIG. 13. is a block diagram of a drift error reduction system for reducing z-axis drift error using a feedback loop control with a binary accumulator in accordance with yet another example; and

FIG. 14 is a plot of elevation versus time for a walk up and down the stairs and along the corridors of a 4-story building using system like that of FIG. 13.

While the disclosed methods and apparatus are susceptible of embodiments in various forms, there are illustrated in the drawing (and will hereafter be described) specific embodiments of the invention, with the understanding that the disclosure is intended to be illustrative, and is not intended to limit the invention to the specific embodiments described and illustrated herein.

### DETAILED DESCRIPTION OF PREFERRED EMBODIMENTS

The present application describes techniques for reducing and even eliminating particular drift errors in gyroscopic tracking systems. Techniques have been developed to process gyroscope data in a feedback control loop configuration and based on a number of environmental assumptions that can be selectively applied or turned-off depending on their perceived applicability. While the techniques are described in more detail, they can result in orders of magnitude of improvement in positional data accuracy from gyroscopic devices. The techniques may be applied to devices of any sort, but in particular those devices used in tracking people, vehicles, remote-controlled devices, and the like. The techniques may allow for tracking in what have been traditionally considered very complex environments, namely indoors, underground, underneath dense foliage, and in “urban canyon” developments of large city centers.

Broadly speaking, two main techniques are discussed herein, “heuristic drift reduction” (HDR) and “heuristic drift elimination” (HDE). Both techniques are able to reduce or eliminate the effects of all slow-changing gyro errors. Both techniques are able to, in real time, estimate and cancel out drift from a gyro's measured angular rate of rotation (also termed the rate of turn or turn rate herein).

Both techniques make use of heuristic assumptions, namely the fact that many of the environments in which GPS and magnetometers are ineffective (e.g., inside man-made structures) have straight-line features. Straight-line features refers to these buildings as having walls, corridors, rooms, stairwells, ramps, etc. that are confined by linear structures, be it the outer walls of the building or the interior walls and structures within the space. Therefore, a first assumption for HDR/HDE is that these systems operate in environments that have straight-line features, which makes sense because most corridors in buildings are straight and so are most walls and sidewalks alongside which a person might walk. And when outdoors, many sidewalks and streets are laid out in a straight-line manner. In any event, as a result of this heuristic assumption, at any moment, the likelihood is that a user is walking along a straight line, certainly when inside a building.

In response to this heuristic, and discussed further below, the HDR technique therefore may correct a gyros output signal to reduce the drift component on that signal by assuming there is a high enough likelihood that regardless of the measured value the user is most likely walking along a straight line for at least certain types of movements. Thus with HDR any output signal from a gyro that does not reflect straight-line movement can be assumed to be erroneous and the result of drift error. This is a straight line-based drift correction. Alternatively, if the HDR technique determines that a user is not walking along a straight line, then the HDR technique will not apply this straight line-based drift correction.

To determine whether to apply drift correction, the HDR technique may use landmarks (i.e., man-made straight-line features), but do so without requiring that the location of these landmarks be known in advance of movement or measurement. HDR applies an intelligent analysis to determine when the straight-line heuristic is to be applied. Once an initial direction is determined, for example, all moves extending therefrom may be treated as occurring in straight lines or as occurring around corners that connect one straight-line path to another straight-line path.

HDE applies two heuristic assumptions: (1) the straight line assumption of HDR, namely that motion happens along straight lines; and (2) that straight lines of motion relate to one another through only certain available angles of intersection (e.g., intersecting at 90 or 45 degrees).

As used herein, a “heuristic” method is one that uses one or more “rules of thumb” to improve the performance of a system. One problem with rules of thumb is that, by definition, they don't always hold true. Therefore, the effectiveness of a method based on heuristics depends strongly on the mechanism with which the method decides whether or not it is appropriate to apply the rule of thumb at any given instance. Applying a rule of thumb when it is not appropriate to do so can cause grave errors. Both the HDR and the HDE method use a “heuristics engine” that is particularly effective at correcting drift when the rules of thumb apply, and at avoiding “corrections” when the rules of thumb don't apply. With both HDR and HDE the heuristics engine is based on a closed loop control system approach. Both the HDR and the HDE techniques may be deployed with any personnel or vehicle tracking system that uses one or more gyros or other sensors for measuring rate of rotation (rate of yaw) to compute user headings. One such personnel tracking system is the so-called “Personal Dead-reckoning” (PDR) and is discussed further in examples below.

### Heuristic Drift Reduction—HDR

To understand the heuristic techniques described herein, it is useful to understand the nature of gyroscopic drift. Suppose a person is walking forward in a straight line, with a conventional gyroscopic tracking device attached to one leg. As the person moves, the output of the z-axis from the device (e.g., the gyroscope that measures the change in heading when traveling on flat, horizontal ground) should be exactly zero throughout the trip. However, due to drift the actual output is off by some small error value, ε. Suppose further that the total travel distance is divided into smaller intervals. A natural choice for an interval length is from footfall to footfall, where “footfall” is a single instance in which the heel or the ball of the person's foot (e.g., on a leg carrying the gyroscopic tracking device) is fully in contact with the ground and the velocity of the sole of the user's shoe is zero. Thus, a “footfall” is an instance within a time period called “midstance” in the analysis of human walking gait (see, e.g., Ayyappa, 1997). If only one foot is instrumented with a gyroscopic tracking device, there will be two steps between footfalls.

Due to the drift error ε in each interval, the rate of rotation computed based on the z-axis gyro is:

ω_{raw}=ωₜᵣᵤₑ+ε₀+ε_{d} [1]

where the ω_{raw} is the rate of rotation measured—i.e., this is the direct output of the gyro. The rate ωₜᵣᵤₑ is the actual, or true, rate of rotation, where in reality ωₜᵣᵤₑ is not known or measured. In an idealized straight-line heuristic example, it is assumed that ωₜᵣᵤₑ=0 for this z-axis gyro. The error value ε₀ is the static bias drift, which may be measured immediately prior to a walk. The error ε_{d} is the bias drift, which is the difference between the static bias drift ε₀ and the unknown near-DC drift component.

Prior to each walk and with the gyroscopic device held completely motionless, the static bias drift ε₀ is measured by averaging T_{bias} seconds worth of gyroscope data. The value for T_{bias} depends on the quality of the gyro and can be estimated various ways, including by the Allan Variance analysis (Ferre-Pikal, E. S. et al., 1997, “Draft revision of IEEE STD 1139-1988 standard definitions of physical quantities for fundamental, frequency and time metrology-random instabilities.” Proceedings of the 1997 IEEE Frequency Control Symposium, 1997, Orlando, Fla., USA, May 28-30, pp. 338-357.). T_{bias} is also called “bias time,” and had a value of T_{bias}=30s in example tests of the HDR techniques.

With the HDR technique, during the walk, the static bias drift error ε₀ is subtracted from every reading of ω_{raw} to produce a corrected rate of rotation value:

ω′_{raw}=ω_{raw}−ε₀=ωₜᵣᵤₑ+ε_{d} [2]

Then, the new heading ψᵢ is computed based off of the prior heading value and the corrected rate of rotation value:

ψᵢ=ψᵢ₋₁+ω′_{raw,i} Tᵢ [3]

where ψᵢ is the computed heading at footfall i, in degrees (°), Tᵢ is the duration of time for interval i, in seconds, i.e., Tᵢ is the time between footfall i−1 and footfall i.

If ε_{d} is positive, then the change of heading is counter-clockwise, which is conventionally called a “left turn” for simplicity. If ε_{d} is negative, then the change of heading is clockwise or a “right turn.”

It is unpredictable whether ε_{d} will be positive or negative, and either way ε_{d} being a drift error may change signs during a walk. When ε_{d} changes signs often during a walk, then drift errors will partially cancel each other out and the resulting overall heading error is less severe. Thus, the greater concern is for situations where ε_{d} keeps the same sign for prolonged periods of time and thereby accrues heading errors in the same direction.

If ε_{d} keeps the same sign throughout the walk, then in each interval Tᵢ the heading error will have the same direction regardless of the unpredictable and ever-changing value of ε_{d}. For a straight-line walk of 2,000 steps for example (i.e., 1,000 footfalls) and assuming ε_{d} is positive, there are 1,000 intervals in which a gyroscope will erroneously perceive that it had turned left due to a positive near-DC drift component. At the same time, that gyroscope will perceive zero intervals in which the device erroneously perceived it had turned right. As discussed further herein, for these situations, the HDR technique may hypothesize that the difference between the number of intervals, in which the PDR system perceived left turns and the number of perceived right turns provides some indication of the direction and magnitude of drift in the corresponding gyro.

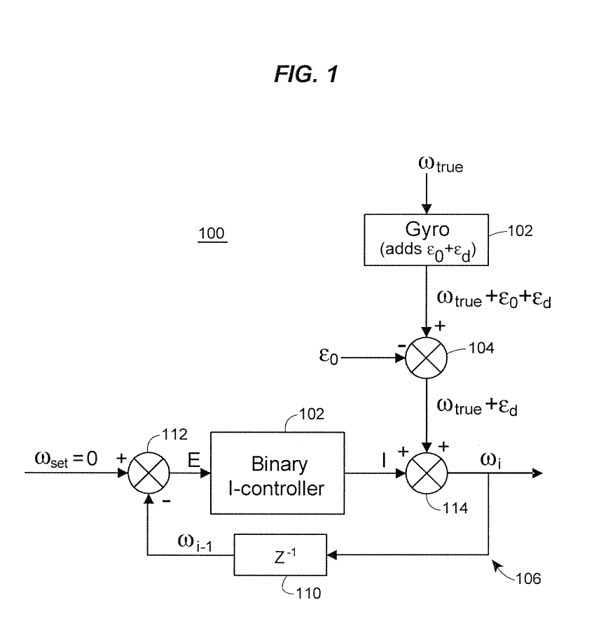

A block diagram of an example HDR engine 100 capable of addressing these situations is shown in FIG. 1. The engine is implemented as a closed loop control system 100. As discussed, the system 100 can reduce drift in extreme examples such as the one above, where a constant, same-sign drift error repeatedly occurs over some length of time, and also in less extreme examples.

For the system 100, the value for ωₜᵣᵤₑ is set to 0 due to the heuristic assumption that the movement being tracked is along a straight-line path. A gyroscope 102 then inherently applies drift errors, modeled as a static bias drift ε₀ and a correctable error drift, ε_{d}, to the ωₜᵣᵤₑ to produce an output rate of rotation ωₒᵤₜ=ωₜᵣᵤₑ+ε₀+ε_{d}. An adder/subtractor 104 subtracts the static bias drift ε₀ from the output value ωₒᵤₜ resulting in a normalized rate of rotation value ωₙₒᵣₘ=ωₜᵣᵤₑ+ε_{d}, as illustrated. Thus, as can be seen, for the closed-loop control system 100, ε_{d} which reflects the sum of all slowly-varying drift errors is a disturbance.

To reduce the drift error, the system 100 relies upon a feedback loop 106 in which the normalized rate of rotation, ωₙₒᵣₘ, is combined with a drift error correction value, I, to produce a corrected rate of rotation, ωᵢ. The feedback error correction loop 106 is controlled by a Binary I-controller 108.

From control theory, the error (E) in a closed-loop control system with a proportional-integral controller (PI-controller), or with just an integral controller, converges to zero in steady state when the control parameters are properly chosen and if the plant is of second or lower order. In the system 100 of FIG. 1, there is only a first order delay resulting from the feedback loop 106; and there is no plant. Thus, in steady state the binary I-controller 108 will produce an inherent error, E, that is zero. This means that the output control signal, I, from the controller 108 will track (but with an opposite sign) the slowly-varying drift errors, ε_{d}, on the signal ωₙₒᵣₘ. Additionally, the output signal, I, tracks this drift error with no delay offset. Thus, the feedback loop 106 and in particular the output of the binary I-controller 108 produces a correction value I≅−ε_{d}.

This output results from the ideal condition when ωₜᵣᵤₑ=0. In application, ωₜᵣᵤₑ can briefly be orders of magnitude larger than ε_{d}, for example, when a person or vehicle turns around a corner. In that case a conventional I-controller would not work, because the I-controller would respond strongly to large values of |ωₜᵣᵤₑ|, thereby overwhelming the integrator in the I-controller. To avoid this pitfall, the binary I-controller 108 is designed to be insensitive to the magnitude of the error signal E, by treating that error signal as a binary signal that can have only one of two values: positive (+1) or negative (−1). Thus, for the integration function of the controller 108, the integration value I is the difference between the numbers of perceived positive error values and the numbers of perceived negative error values. In other words, the value I is the difference between the left and right turns, using the conventions discussed above.

The feedback loop 106 includes a buffer block 110 that produces a previous rate of rotation value, ωᵢ₋₁. In the illustrated example, a setpoint rate of rotation, ωₛₑₜ, is permanently set to zero, in which case when ωᵢ₋₁>0 (a perceived left turn), the error input value E is negative, and when ωᵢ₋₁<0 (a perceived right turn), the error E is positive. The value E results from adding the previous rate of rotation value, ωᵢ₋₁, with the setpoint rate of rate rotation, ωₛₑₜ, via an adder/subtractor 112. The binary I-controller 108 therefore may be programmed to integrate, which is an increment in this example, each value I as follows

$${I}_{i} = \{ \begin{matrix}{I}_{i - 1} - {i}_{c} & for & {ω}_{i - 1} > 0 & ( a perceived left turn ) \\ {I}_{i - 1} + {i}_{c} & for & {ω}_{i - 1} < 0 & ( a perceived right turn )\end{matrix} \qquad [ 4 a ]$$

where i_{c} is a fixed increment [°/sec].

An alternative way of writing Eq. 4a is

Iᵢ=Iᵢ₋₁−SIGN(ωᵢ₋₁)i_{c} [4b]

where SIGN( ) is a programming function that determines the sign of a number. SIGN(x) for example returns ‘1’ if x is positive, ‘0’ if x=0, and ‘−1’ if x is negative.

Another adder/subtractor 114 in the control loop 106 adds the controller output value, I, to the normalized raw measurement and produces the corrected rate of rotation value, ωᵢin °/sec, as follows:

ωᵢ=ωₜᵣᵤₑ+ε_{d}+Iᵢ. [5]

With I≅−εd, under ideal conditions, in steady state, and using the closed loop control system, then by substituting I≅εd in Eq. [5], it is shown that:

ωᵢ≅ω_{true,i}. [6]

That is, the system 100 employs a feedback closed loop control having a binary increment controller that, at least in many conditions, will reduce or remove the slow-varying drift error inherent to gyro operation.

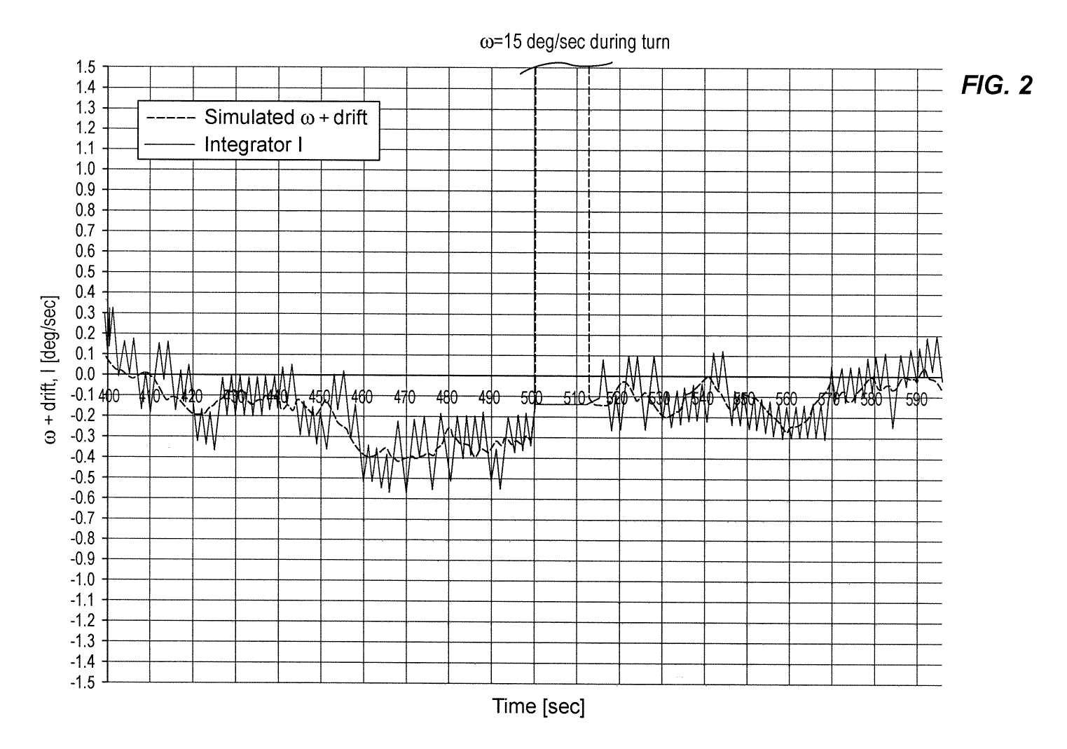

FIG. 2 is a plot of time versus the output rate of rotation ωᵢ from the HDR engine 100 in an example simulation in which a subject moves straight in the forward direction from time t=400 to t=500 sec, and then from t=501 to t=512 the subject turns 180 degrees and then moves straight again, this time in the backward direction. Plot 200 shows the simulated ωₜᵣᵤₑ+ε_{d}. Plot 204 shows how well the output increment value, −I, tracks this drift and indeed oscillates to some extent around the simulated drift value with an amplitude of i_{c}. At t=501, the HDR system detects (in a way that will be explained later) that the subject is turning and “freezes” the binary I-controller 108 from collecting I, thereby effectively disabling the feedback loop 106 and preventing the system 100 from producing increasingly erroneous drift correction data. That is, the HDR system intelligently determines when to turn off of the controlling heuristic assumption that all movement is in a straight line. Continuing on, the HDR system is designed such that once the turn condition ends at t=512 sec, the binary I-controller 108 begins incrementing −I repeatedly until −I is caught up with drift, whereafter the increment value −I continues to track drift again.

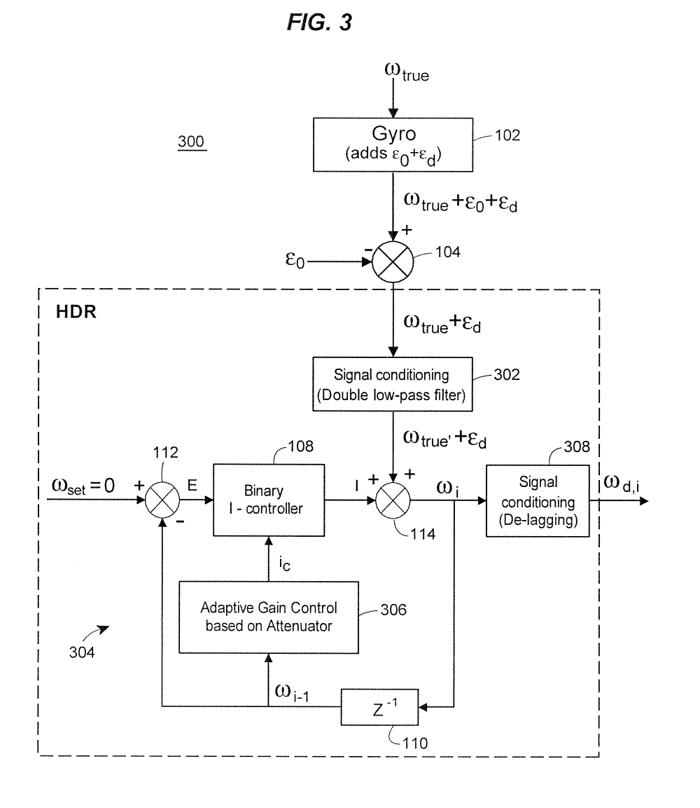

FIG. 3 shows a modified HDR system 300, that shares similar elements to those of the HDR system 100 of FIG. 1 but which is adapted to extend beyond the straight-line heuristic discussed above, to further address common deviations from that heuristic. More specifically, the HDR system 300 is able to counteract three common deviations from straight-line movement: swaying, curving, and turning.

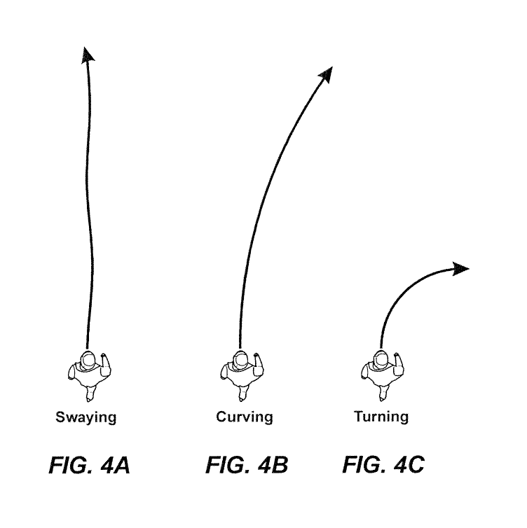

Swaying motion is motion that is intended to be straight but is not entirely straight due to the nature of walking of the person, driving of the vehicle, etc. An example for swaying is shown in FIG. 4A. Swaying produces very minor perceived left and right turns predominantly at the same frequency, at which footfalls occur (about 1 Hz). There is also a lower-frequency sway, due to the difficultly of walking or driving along a perfectly straight line. The movement of an intoxicated person is an extreme example of such low-frequency swaying.

Curving is the motion along an extended arc as shown in FIG. 4B. This motion is potentially the least favorable one because extended walking along an arc with a very large radius can be perceived continuously as slowly-varying drift error on an otherwise straight-line movement and thus counteracted by the HDR system. For example, if the arc curves to the left, while the actual drift error in the measured rate of rotation is to the right, then an HDR system could counteract the perceived left turns and increase the correction value, I, thereby actually increasing the error caused by drift alone. To address this common deviation, the HDR system may be designed to detect curving movement and then reduce the amount of correction applied by HDR during curving motion.

Turning is a sharp but short change of direction as shown in FIG. 4C. Examples are street corners or connections between corridors in a building. Turns are readily identified because the gyro measures much larger rates of rotation during turning than what can be expected as a result from drift. Thus, the HDR system may perform a simple test to identify a turning condition: namely if |ω| is larger than a threshold, then Eqs. 4a and 4b can be skipped altogether.

Returning to FIG. 3, in addition to the elements of system 100, the HDR system 300 includes a first signal conditioner 302 coupled to receive the normalized output, ωₙₒᵣₘ=ωₜᵣᵤₑ+ε_{d}, from the adder 104. The conditioner 302 may be a low-pass filter stage through which the signal ωₙₒᵣₘ is passed to produce a filtered signal ω″=ω_{true′}+ε_{d} that is then corrected through a feedback loop 304. As a low-pass filter, the conditioner 302 helps reduce the effects of swaying, for example, by effectively applying a slow-varying envelope to the gyroscope's normalized rate of rotation signal, ωₙₒᵣₘ.

For certain moves, such as walking, where there may be a large amount of signal noise, the stage 302 may be implemented as a double low-pass filter. For example, a frequency of about 1 Hz is roughly the frequency at which footfalls occur in normal walking. So, for tracking a person walking, the stage 302 may be a double low-pass filter with a time constant of τ=8 sec (i.e., a cut-off frequency of f_{c}=1/τ=0.125 Hz). The time constant and filter bandwidth can be set as desired to improve signal reception. However, this particular example time constant has been used effectively to smooth out much of the noise specific to swaying in walking.

An example, double low-pass filter implementation is as follows:

$$\begin{matrix}{ω}_{i}^{′} = \frac{{ω}_{raw , i}^{′} {T}_{i} + τ {ω}_{i - 1}^{′}}{{T}_{i} + τ} \\ and & [ 7 a ] \\ {ω}_{i}^{′′} = \frac{{ω}_{i}^{′} {T}_{i} + τ {ω}_{i - 1}^{′′}}{{T}_{i} + τ} & [ 7 b ]\end{matrix}$$

where Ti is the time interval, e.g., since the previous footfall and ω′, ω″ are the rates of turn after the first and second stage of the double low-pass filter, respectively.

For signals that are less noisy, such as with driving movement of a vehicle,—the signal conditioner 302 may apply a milder smoothing effect to counteract the effect of swaying. There, the conditioner 302 may be a single-stage low-pass filter, producing only ω′.

The HDR system 300 also includes an adaptive gain controller 306 that may be used to reduce drift during curving or turning motion. Without a strong double low-pass filtering from conditioner 302, a simple threshold would be sufficient to distinguish between the large absolute values of ω due to turning and the much smaller values of ω due to drift. However, the low-pass filtering of conditioner 302 may reduce the absolute values of ω, which makes them harder to distinguish from drift.

Therefore, in order to reduce or eliminate the effect of large |ω| due to curving or turning, the adaptive gain controller 306 is configured to adaptively modify a fixed increment value, i_{c}, that is used by the Binary I-controller 108 to approximate the inverse drift error value. The controller 306 may adjust i_{c} based on at least two determinations. First, the controller 306 may include a repetition counter that responds to long periods of time during which I is not oscillating about a zero value—straight-line movement assumes at least partial oscillation about a zero value—by gradually reducing the increment factor i_{c} over these prolonged periods of non-oscillation. These prolonged periods are considered periods over which slow curving is occurring. The effect is that the HDR feedback loop 304 would be turned off while curving is detected and turned back on after straight line movement is resumed. Reducing the value of the increment factor i_{c}, for example, reduces the effect of the feedback loop 304.

In implementation, a “repetition counter,” R, of the controller 306 is incremented by ‘1’ for every actual iteration, in which the sign of ωᵢ₋₁ remains unchanged from that of ωᵢ₋₂ (note that since Rᵢ is used to compute ωᵢ, the controller 306 goes back two iterations, to Wᵢ₋₂, to see if the sign has changed).

$${R}_{i} = \{ \begin{matrix}{R}_{i - 1} + 1 & for & SIGN ( {ω}_{i - 1} ) = SIGN ( {ω}_{i - 2} ) \\ 1 & for & SIGN ( {ω}_{i - 1} ) \neq SIGN ( {ω}_{i - 2} )\end{matrix} \qquad [ 8 ]$$

Then, the original increment factor, i_{c}, is reduced in (nearly) inverse proportion to R, using the expression:

$${i}_{c , i}^{′} = \frac{{i}_{c}}{1 + {r}_{c} {R}_{i}} \qquad [ 9 ]$$

where r_{c}—Constant for tuning the weight of the repetition counter.

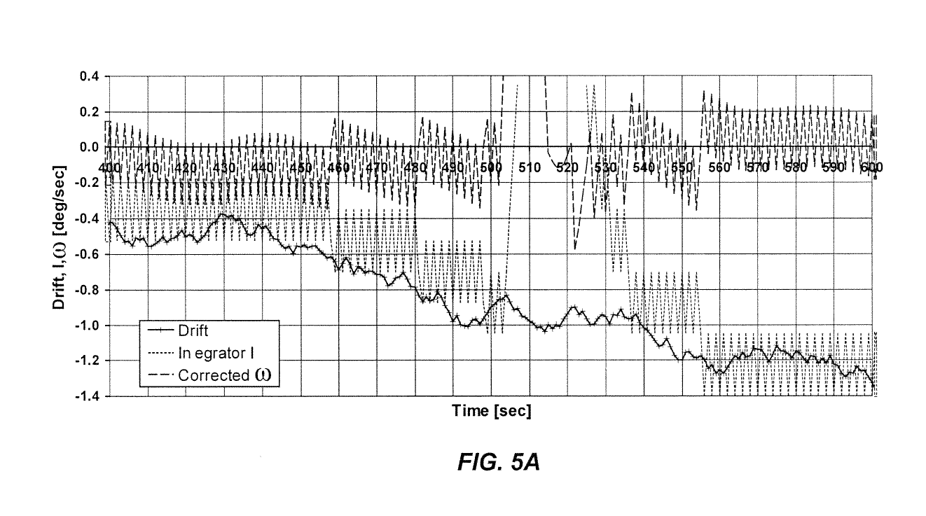

The effect of this determination is that/grows rapidly only immediately after a change of sign, and then, after a few more steps, becomes stagnant as long as ω retains the same sign. As a result, low-pass filtered sharp turns or continuous slight turns cannot continue to affect the value I for more than a few steps. This effect is illustrated in the example of FIG. 5a, where because of the repetition counter enhancement to the controller 306, the area between the −I curve and the drift curve is smaller than the comparable area in FIG. 5b.

As a second technique for adjusting, the adaptive gain controller 306 may be configured to change the increment factor, i_{c}, in inverse proportion to the magnitude of |ω|. As with the foregoing, by changing the value of this factor, system 300 controls the gain of the feedback loop 304, which will allow for selective attenuation of the effect of the feedback loop 304. This is particularly useful in reducing drift correction errors resulting from curving or turning. For small |ω|, for example, the Binary I-controller 108 may change I with the normal increment factor i_{c}, whereas for larger |ω| the controller 108 will controllably diminish the fixed increment i_{c}, because that larger |ω| suggests actual curving.

The controller 108 may be adapted to gradually reduce the effect of HDR, but only as long as the perceived curving motion (i.e., the larger |ω|) persists. If the perceived curving motion ceases to persist, then the controller 306 would cease its attenuation of the increment value, i_{c}, and the feedback loop 304 would cease attenuating the signal, I. To allow the controller 306 to make the foregoing determinations, the controller 306 is coupled to the delay stage 110.

To achieve the desired gain/attenuation effect on, i_{c} the controller 306 may multiply i_{c} with an attenuation factor A, as shown:

$${A}_{i} = \{ \begin{matrix}1 - \frac{\vert {ω}_{i - 1} \vert}{{θ}_{w}} & for \vert {ω}_{i - 1} \vert \leq {θ}_{w} \\ 0 & for \vert {ω}_{i - 1} \vert > {θ}_{w}\end{matrix} \qquad [ 10 ]$$

where θ_{w} is a threshold value.

The closed-loop control system 100, implementing a repetition counter, under this example can thus be modeled as follows:

$$\begin{matrix}{I}_{i} = {I}_{i - 1} - {A}_{i} \frac{SIGN ( {ω}_{i - 1} ) {i}_{c}}{( 1 + {r}_{c} {R}_{i} )} \\ and & [ 11 ] \\ ω i = {ω}_{i}^{′′} + {I}_{i} . & [ 12 ]\end{matrix}$$

FIG. 5c shows the effect of both a repetition counter and an inverse proportion increment adjustor in the controller 306 to compensate for curving or turning conditions. The addition of the attenuator and threshold enhancement. The area between the drift curve and the I-curve between t=500 and t=530 is further reduced, compared to FIG. 5b. This area translates directly into the heading error caused by the curving event that started at t=500 sec, and is thus substantially reduced in this example.

If the stage 302 is a double low-pass filter, depending on the implementation, there is the likelihood that the HDR-corrected rate of rotation, ωᵢ, as determined by Eq. (10) will lag behind the raw value ωᵢ. If uncorrected, the subject's trajectory as determined based on ωᵢ could be an inaccurate representation of the true trajectory, e.g., where sharp turns are treated by the HDR system as prolonged curves. To address this, the HDR system 300 includes a second signal conditioner 308 that applies de-lagging to the input rate of rotation signal ωᵢ. More specifically, the log effect can be removed by reversing the effect of the double low-pass filter from the signal condition 302 and producing the output rate of rotation, ω_{d,i} Inverting Eqs. (6a) and (6b) results in:

$$\begin{matrix}{ω}_{i}^{*} = {ω}_{i} + \frac{τ}{{T}_{i}} ( {ω}_{i} - {ω}_{i - 1} ) \\ and & [ 13 ] \\ {ω}_{d , i} = {ω}_{i}^{*} + \frac{τ}{{T}_{i}} ( {ω}_{i}^{*} - {ω}_{i - 1}^{*} ) & [ 14 ]\end{matrix}$$

where ω_{d,i} is the final, HDR-corrected and de-lagged rate of turn.

From this, the HDR system may determine the corrected heading value by revising Eq. (3) as follows:

ψᵢ=ψ₀+ψᵢ₋₁+ω_{d,i}Tᵢ [15]

where ψ₀ is the initial heading at the beginning of the walk. The trajectory can be determined as:

xᵢ=x₀+Dᵢ cos ψᵢ [16]

yᵢ=y₀+Dᵢ sin ψᵢ [17]

where x₀, y₀ are the initial position coordinates of the subject, and Dᵢ is the distance traveled in interval i, as estimated.

Thus, the HDR system is able to reduce errors due to gyro drift in a personnel tracking system using a basic heuristic assumption that walking and driving both happen along reasonably straight lines. Whenever that is the case, the system applies a controller using a closed-loop control approach that produces an output, −I, that tracks the near-DC component of the drift, and thus may be subtracted from the gyro-measured rate of rotation to effectively eliminate drift. The HDR system may further include an attenuation controller that effectively suspends HDR feedback loop operation during actual curving motion. Then, when straight line motion resumes, the HDR correction resumes and the feedback loop again starts tracking the slowly-varying drift. While the HDR system is still susceptible to heading errors, e.g., when the HDR system is suspended, the HDR system has been shown to nonetheless improve personal tracking devices plagued with slowly-varying drift errors—as defined above these errors include drift errors as well as of the gyros' sensitivity to linear accelerations and temperatures—reducing both drift and heading errors by one order of magnitude. Furthermore, the HDR system can make these corrections in real-time while walking. Furthermore, the HDR system can be implemented in existing gyroscopic devices, without requiring substantial retrofitting.

### Heuristic Drift Elimination—HDE

Whereas the HDR systems discussed herein may improve rate-of-rotation measurements, HDE systems further improve the heading measurements determined from gyroscopic data.

HDE systems are built upon two heuristic assumptions. The first is that of the HDR systems 100 and 300 discussed above, namely that motion occurs along a straight line. The second is that most buildings have a footprint that is either rectangular or comprised of several rectangles. From this second heuristic, directions that are parallel to the sides of a building's rectangular footprint are called “dominant” directions. While one can think of exceptions to this assumption (e.g., the Pentagon in Washington, D.C., USA, and some works of modern architecture), the overwhelming majority of buildings have four dominant directions, ψ, spaced at 90-degree intervals. This interval is called the “dominant direction interval,” and is Δ=90° in the typical example.

Attendant to the second heuristic assumption is that most corridors and inside walls in a rectangular-footprint building will run parallel to one of the dominant directions of that building. If this attendant assumption is true, than one can further assume that most walking inside such buildings is also done along dominant directions. The HDE engines described herein are designed to correct heading errors based on these attendant assumptions, although in some examples described herein HDE engines are able to effectively deal with situations in which these attendant heuristic assumptions are not valid.

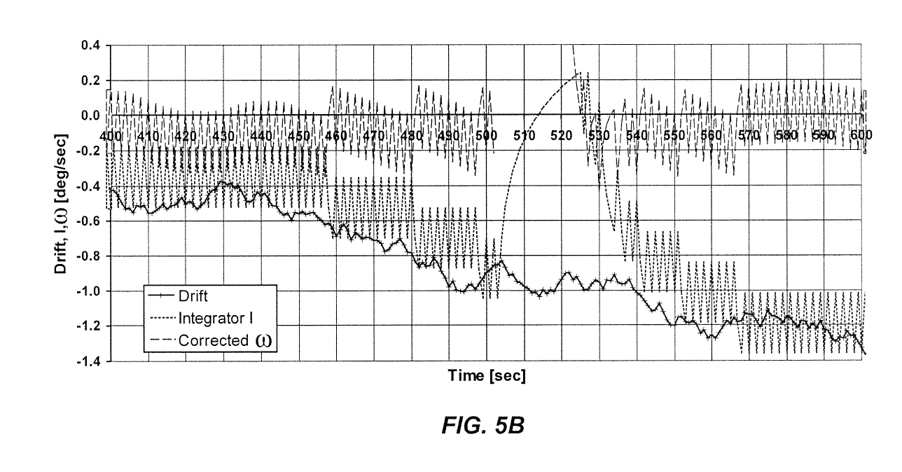

FIG. 6 illustrates an example HDE system 400 implemented as a closed loop control system. For the HDE system 400, it is initially assumed that a user is walking in a straight line and along a dominant direction, leaving ωₜᵣᵤₑ=0. A gyroscope 402 then inherently applies drift errors, modeled as a static bias drift ε₀ and a correctable error drift, ε_{d}, where the former is removed by a subtractor 404 to produce a normalized rate of rotation ωₙₒᵣₘ=ωₜᵣᵤₑ+ε_{d}.

This normalize rate of rotation is added to the output of a binary I-controller 406 by an adder 408. Initially, the output of the I-controller 406 is zero, so ε_{d} is passed through to a numeric integrator 410, which integrates the resulting corrected rate of rotation and computes the relative change of heading, ψᵢ.

To form the closed loop, the output heading value, ψᵢ, is coupled to a buffer 412 and then to a low-pass filter 414. The output from the low-pass filter 414 is then mapped onto a dominant direction using a MOD controller 416. More specifically, as discussed further below, the output is mapped on a dominant direction that lies between 0 and Δ using the MOD function discussed herein. The resulting mapped heading value, ψ*ᵢ₋₁, is then compared to a fixed set point heading value, ψₛₑₜ=Δ/2, using a comparator 418 (e.g., a subtractor). The resulting signal is the error signal, E, for the closed loop and that is provided to the Binary I-controller 406.

The MOD controller 416 applies a MOD function, labeled “MOD(ψ,Δ), on incoming data. While the “MOD” function can vary, for the particular example of FIG. 6 the MOD function implemented in Microsoft Excel was used. This MOD function has two arguments (n, d) and returns the remainder after n is divided by d, and the result will have the same sign as d. The MOD function therefore can be expressed as:

MOD(n, d)=n−d INT(n/d) [18]

where INT(r) is a function that rounds a real number r down to the nearest integer, e.g., INT(−0.3)=−1.

When n and d are angles, then MOD(n,d) performs a highly useful function: it maps an angle of any magnitude n onto a sector that is bounded on one side by the positive x-axis and that has a central angle of d.

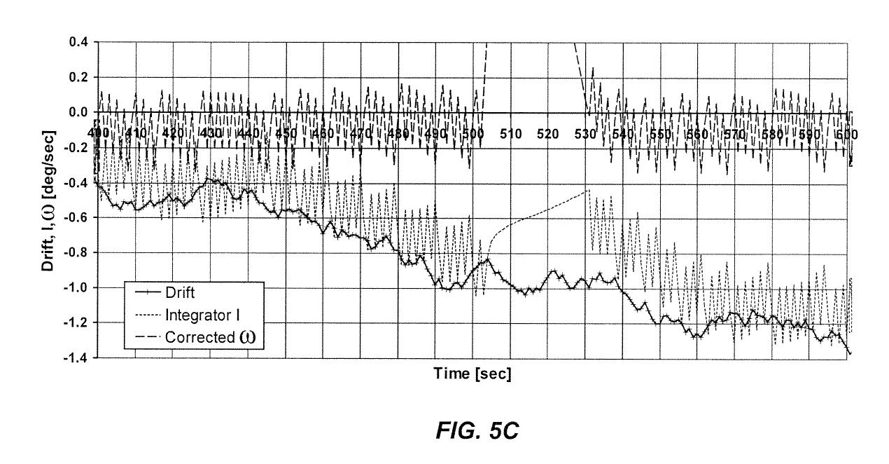

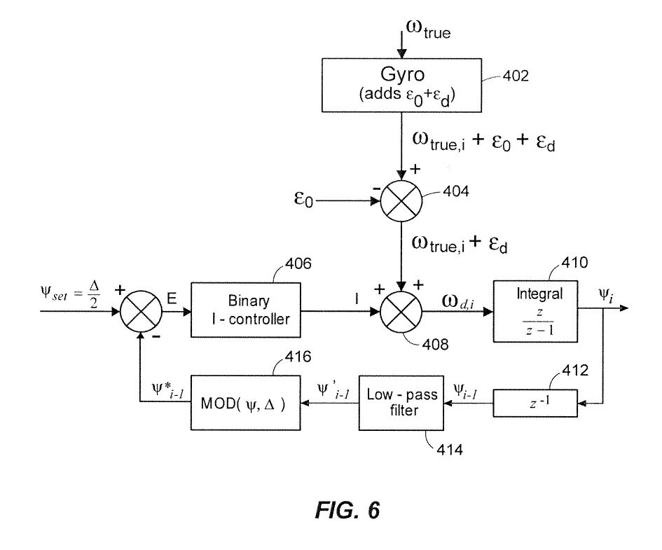

Generally speaking, the MOD function can map a heading feedback value onto one of a plurality of dominant directions as illustrated by example in FIG. 7A. A floor plan is illustrated and has a general direction of the corridors as highlighted. The four primary dominant directions (0°, 90°, 180°, and 270°) are typically those that are parallel to the walls and main corridors of the building. The secondary dominant directions (45°, 135°, 215°, and 315°) intersect primary ones at angles of 45°. As applied to this example, the MOD function can be adapted to map to any of the primary dominant directions, any of the secondary dominant directions, or any of both of primary and secondary dominant directions.

As an example, consider the two sub-sectors labeled ‘R’ and ‘L’ in FIG. 7B. Together, these two sub-sectors form a single sector with a central angle of 90° that coincides with the first quadrant of a coordinate system. The function MOD(n,90) maps any angle n, which may be greater than 360° or negative, onto Sectors R and L. Similarly, MOD(n,45) maps any angle n onto Sector L.

The MOD controller 416 having a MOD function of MOD(ψ,Δ) with Δ=90° would map any heading value, ψ, onto either sub-sector R or sub-sector L. The functional significance of this MOD function is that in a building with four dominant directions ψ=90°, 180°, 270°, and 360° (=0°) any momentary heading direction that is immediately to the right of any of these four dominant directions will be mapped into sub-sector R—“immediately to the right” refers to angles that are between ψ and ψ−Δ/2, which is sub-sector R in FIG. 7B.

Similarly, any heading direction that is immediately to the left of any of these four dominant directions will be mapped into sub-sector L—“immediately to left” refers to angles between ψ and ψ+Δ/2 which is sub-sector L.

As an example, consider when an HDE equipped personal tracking device has a momentary heading of ψ=−25°. This is immediately to right of the dominant direction ψ=0°. The result of applying the MOD function is MOD(−25°,90°)=65°. 65° is also immediately to the right of a dominant direction, namely ψ=90°. If the user turned three full revolutions in counter-clockwise direction (e.g., by climbing up three flights on a switchback staircase), the user's heading should still be immediately to the right of a dominant direction. The user's new heading could be represented as ψ=−25°+3×360°=1055°. The MOD controller 415 maps the new heading right back to ψ*=MOD(1055°,90°)=65° which is, as before, immediately to the right of a dominant direction.

Thus, the MOD controller 416 performs a test to determine if a momentary heading angle is immediately to the right or left of any dominant direction (collectively referred to as Eq. [19]):

If ψ*=MOD(ψ,Δ)>Δ/2 ψ is immediately to the right of a dominant direction ψ.

If ψ*=MOD(ψ,Δ)=Δ/2 ψ is perfectly aligned with a dominant direction ψ.

If ψ*=MOD(ψ,Δ)<Δ/2 ψ is immediately to the left of a dominant direction ψ.

The binary I-controller 406 operates in a similar manner to that of the controller 108. Generally speaking ωₜᵣᵤₑ=0 is an ideal condition that is often not met. As discussed above, ωₜᵣᵤₑ can briefly be orders of magnitude larger that ε_{d}, for example, when the user walks around a corner. To avoid responding strongly to large values of |ωₜᵣᵤₑ|, and thereby overwhelming the integrator in the I-controller, the I-controller 406 is a binary controller like to that of binary I-controller 108.

As established by Eq. [19], if ψ*>ψₛₑₜ, then ψ* is immediately to the right of ψ, and if ψ*<ψₛₑₜ, then ψ* is immediately to the left of ψ. During straight-line walking along a dominant direction ψ, a heading computation to the right of ψ suggests that the only possible source for this error, ε_{d}, had a negative value. Therefore, to counteract this error, the binary I-controller adds a small increment, i_{c}, to an internal accumulator, or “integrator,” value I. Conversely, if ψ*<ψₛₑₜ, then the integrator I is decremented by i_{c}. This operates in the similar manner to the binary I-controller 108 but is applied to the heading values.

The binary I-controller 406 applies an integrator value I according to the following—this formulation can be compared against Eq. [4b] above:

$${I}_{i} = \{ \begin{matrix}{I}_{i - 1} - {i}_{c} & for & {ψ}_{i - 1}^{*} > \frac{Δ}{2} \\ {I}_{i - 1} + {i}_{c} & for & {ψ}_{i - 1}^{*} < \frac{Δ}{2}\end{matrix} \qquad [ 20 ]$$

where i_{c} is the fixed increment [°/sec] and ψ*=MOD(ψ,Δ) is the normalized heading angle. An alternative way of writing Eq. [20] is

$${I}_{i} = {I}_{i - 1} - SIGN ( {ψ}_{i - 1}^{*} - \frac{Δ}{2} ) {i}_{c} \qquad [ 21 ]$$

where SIGN( ) is a function as discussed above.

The adder 408 adds the controller output, integrator value I, to the normalized rate of rotation to produce the corrected rate of rotation ωᵢ=ωₜᵣᵤₑ+ε_{d}+Iᵢ[°/sec], which is the same as Eq. [5] and reduces to that of [6] under the conditions discussed above.

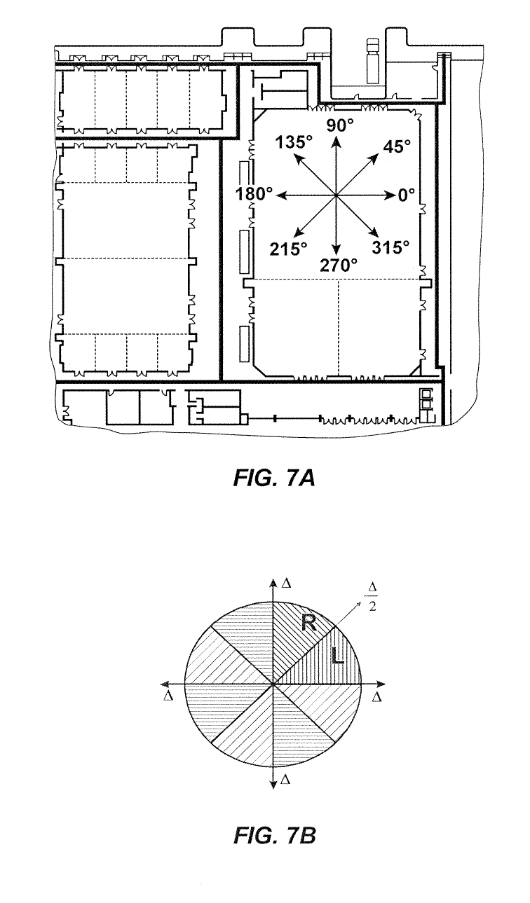

FIG. 8 illustrates a process 500 implemented by an HDR/HDE engine of gyroscopic vehicle or personal tracking device. Initially, the gyroscope assembly of the tracking device is calibrated at block 502 to determine static bias drift. For example, during the initialization phase, immediately prior to a walk, the user stands still for 25 seconds and the process measures ε₀ for all three gyros in a foot-mounted internal measurement unit (IMU) such as discussed below During operation, the gyro (block 504) measures a rate of rotation, which inherently includes drift error, and provides that rate of rotation to a normalizing block 506 that removes the static bias drift. The block 506 may also optionally condition the rate of rotation, for example by applying a low pass filter to the normalized rate of rotation. A block 508 compares the normalized rate of rotation to a predetermined set rate of rotation and passes that compared value to an accumulator 510, which in turn assesses the accumulated error in the rate of rotation signals from the gyro, over time. In the examples of devices 100 and 300, for example, the accumulator 510 is implemented as a binary I-controller. The accumulator 510 produces an error correction signal that is compared against the normalized rate of rotation (block 512) received from block 506 to produce a corrected rate of rotation in which the drift error has been removed or substantially reduced. Optionally, the block 512 may perform further signal conditioning on the corrected rate of rotation, as desired.

The output of the normalizing block is also provided to heading error correction that includes an integrator (block 514) that determines an initial heading value from the normalized rate of rotation. That heading value is passed through a signal conditioner 516, e.g., a low pass filter, and then to a mapping block 518 which maps the heading value using heuristic assumptions about the environment through which the tracking device is to navigate. For example, the mapping block 518 may apply a MOD function to a set of dominant directions that define the heuristic assumptions. The output from the mapping block 518 is compared against a predetermined heading value (e.g., an initial heading value determined by the calibration block 502), and that compared value (from block 520) is provided to an accumulator 522, similar to accumulator 510. The output from the accumulator 522, though based on a comparison of heading values, reflects the amount of drift error in the rate of rotation. A comparator 524 removes that drift error from the normalized rate of rotation, and another integration is performed (block 526) to produce the corrected heading value.

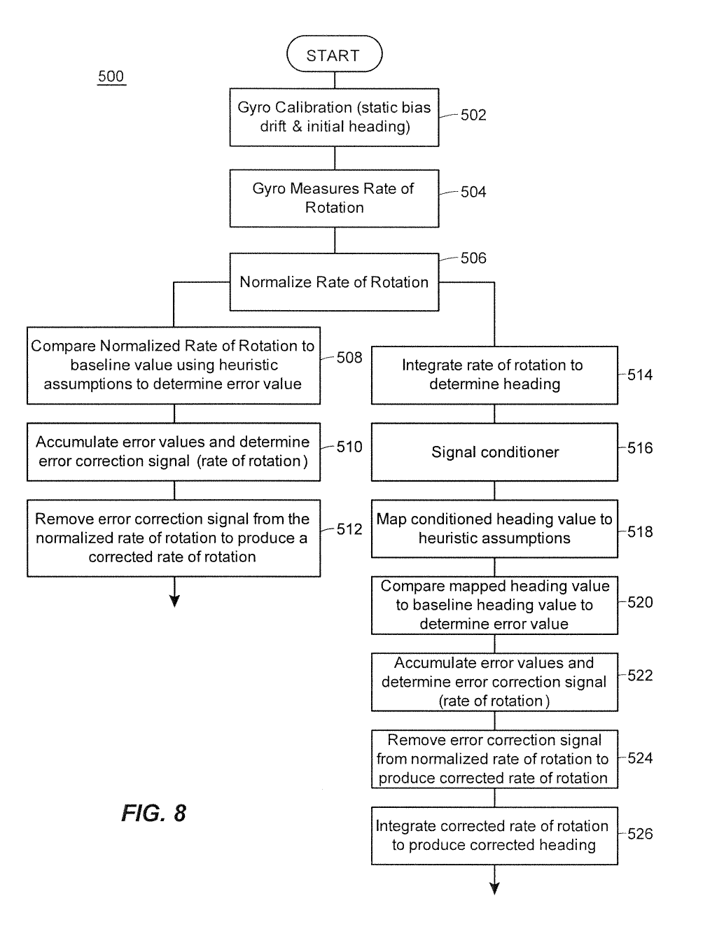

The above described techniques may be implemented in any tracking device, whether a personal (personnel) tracking device or a vehicle tracking device, in an enclosed environment or an open one. An example implementation is that of a personal dead-reckoning system 600 shown in the block diagram of FIG. 9. The system 600 includes an inertial measurement unit (IMU) 602 which will contain one or more gyroscopes. If multiple gyros are used, then one may be assigned to each of orthogonal coordinate axes. The IMU 602 would preferably include an attachment mechanism to allow for ease of carrying. If the IMU 602 is to be attached to a shoe or lower part of a user's leg for example, the IMU 602 could have fastenable attachment mechanism to allow for quick attachment and release, but that is sturdy enough to maintain the device in position during a user's movement. A VELCRO strap that attaches to a housing of the IMU 602 containing the gyro(s) would be an example. The IMU can also be embedded in the heel of a boot. Alternatively, the IMU may be worn anywhere else on the body, for example, in the belt pack at the hip, or in a backpack.

The output from the IMU 602 is connected via a sheathed, protected cable, a wire, or wirelessly (e.g., Bluetooth) to main assembly 604. In some examples that main assembly 604 may be a separately attachable assembly, such as a belt-pack, shoulder strap device, etc. that can be easily carried by the user. In other examples, however, that assembly 604 may be contained in the same housing as the IMU 602. In either case, the assembly 604 includes an embedded controller 606 and a power supply 608 for the assembly 604 (e.g., a lithium-polymer battery pack). The controller 606 may be a microprocessor or any integrated circuit, an application specific integrated circuit (ASIC), field programmable gate array, or any other controller device capable of executing instructions as described herein. More specifically, the controller 606 may execute, among other things, one of the HDR and/or HDE techniques described herein.

The controller 606 may communicate data back and forth with a memory 609, which in the illustrated example is shown external to the controller 606. For example, the controller 606 may store in the memory 609 the rates of rotation and heading deviation values determined from the IMU 602. The assembly 604 optionally includes a display 610 capable of displaying some visual indication of device operation and error. The controller 606 could also be programmed to 610 indicate to a user the operating state of the HDE and HDR engines.

In the illustrated example, the assembly 604 includes a communication interface 612, which may be a wired interface such as an RS-232 interface or a wireless interface, and which communicates data between the device 600 an external tracking system 614. For example, the device 600 may transmit a stream of x, y, z position and heading data to system 614. The system 614 may be a centralized tracking terminal, computer, network access point, etc. that is capable of tracking rate of rotation and heading data from the device 600. For example the system 614 may track this data as part of a multiple person tracking system, where it is desirable to know the location of multiple individuals at any given time. The data from numerous different devices 600 could be collected and evaluated by the system. An example implementation would be personnel on a military base, patients in a hospital, the incarcerated in a housing facility, vehicles in a geographic area covered by the system 614. Other examples will be known. Depending on the size of the coverage area, the interface 612 could be a cellular interface and the system 614 would then represent a base station or other node capable of facilitating communication with a network.

As an integrated system, the system 614 could include reference data such as maps of buildings, streets, etc. that represent the areas through which the device 600 is assumed to navigate. The system 614, for example, could record and display the position of the device 600 overlaid against a map of a known location, such as a building. The system 614 may be further programmed to provide additional corrective data, for example correcting overall heading data, by comparing the HDE-corrected data from the device 600 against the reference data in the system 614. If there are discrepancies, the system 614 could correct the heading data that is stored or displayed therein.

In some examples, the system 614 may communicate instructions to the device 600, for example, to program the device with the appropriate number of dominant directions to be used for the MOD controller 416. The values and numbers of dominant directions can be different and they can be programmed to match the dominant direction defined by a building or area map stored at the system 614.

The device 600 measures rate of rotation and heading in real time and communicates that information to the system 614 in real time, through the interface 612. There may be periods over which the system 614 does not receive such data, for example, when the device 600 is in remote locations within a building. To facilitate full data transfer, the device 600 and the system 614 may use a communication protocol by which data is continuously transferred from the device 600 to the system 614, and by which the system 614 may periodically (or continuously) acknowledge receipt of such data. In this way, if the device 600 determines at the time of the next update signal from the system 614 that the system 614 did not receive the recent rate or rotation or heading data, then the device 600 may resend that data, collecting it from the memory 609. The controller 606 may be programmed to store measured rate of rotation and calculated heading data in the memory 609 until receiving an acknowledgement receipt from the system 614.

The IMU 602 may measure linear displacement by employing a technique termed “Zero Velocity Update” (ZUPT), which allows for more accurate linear measurements from accelerometers combined with gyroscopic devices. The ZUPT technique is based on the fact that during every footfall, when the ball of the foot is firmly on the ground, the velocity of the sole at that point is zero. If velocity computed from accelerometers in the IMU device 602 is not equal to zero, then the accelerometers must be wrong and the IMU device 602 can compute by how much the accelerometers are erring. A more detailed explanation of a personal-dead reckoning system employing the ZUPT technique is provided in Ojeda, L. and Borenstein, J., “Non-GPS Navigation for Security Personnel and Emergency Responders.” This Journal. 60, 391-407, 2007.

It is noted that the ZUPT technique is only applied to accelerometers, not to the gyros in the IMU 602. This is because even at footfall, gyro data is typically too noisy to get a single, representative reading of rates of rotation. As a result, drift in the gyros is not eliminated through a ZUPT process. For the roll and pitch axes gyros, this is not a problem, because the assembly 604 can bound the errors from these gyros by tilt data provided by the accelerometers during footfall. For the z-axis gyro, the HDE/HDR engine removes rate of rotation and heading errors.

Correcting for a gyro's undesirable sensitivity to linear accelerations is particularly difficult because of the complex spatial motion performed by the foot during walking. However, it is reasonable to assume that the acceleration sensitivity, which follows similar patterns during each step, can be averaged over several steps and considered as a near-constant—but unknown—disturbance, as long as the user's gait stays the same. When the user changes gait, then the value of that near-constant disturbance changes. For this reason, the acceleration sensitivity acts much like gyro drift. The HDR and HDE techniques described herein are able to successfully reduce these large errors regardless of whether they were caused by drift alone or by the combined effects of drift and acceleration sensitivity.

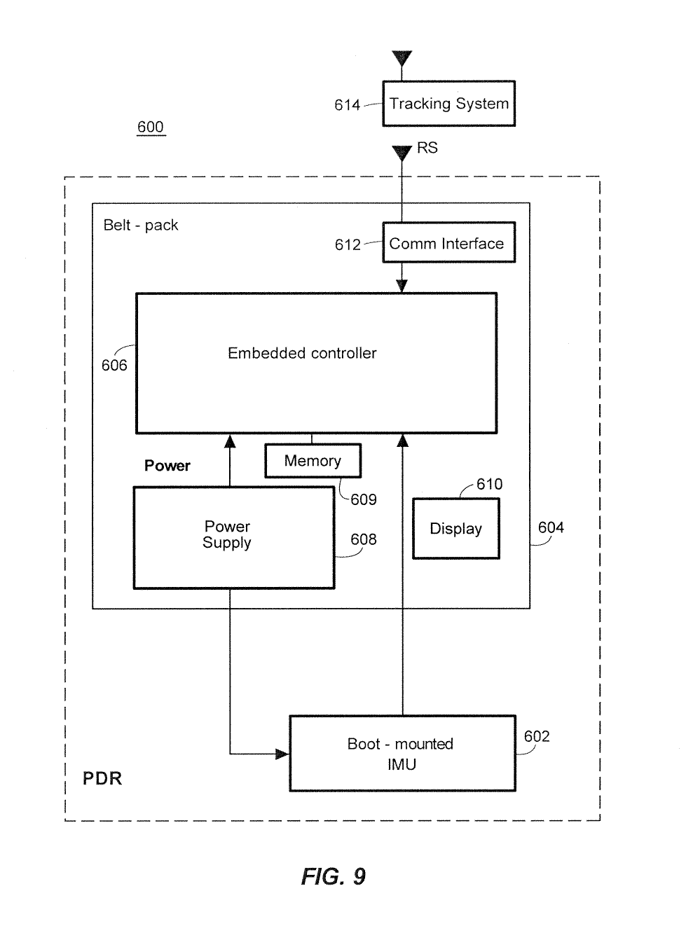

FIG. 10 illustrates an aerial, satellite view of a layout 700 used for testing an HDR system in accordance with the teachings herein. The layout 700 is that of a portion of the North Campus at the University of Michigan, in Ann Arbor, Mich. A test person having an HDR equipped personal tracking device walked along path 702 around the layout 700. The total walking distance of the closed-loop path was about 1,800 m (1.12 miles). Multiple test walks were talking, where the duration of these walks was on average 20 minutes. A particular challenge is the continuously curved street (Beal Avenue) on the east side. As discussed earlier in this paper, continuous curving is a challenge for the HDR algorithm because a continuous curve is difficult to distinguish from the perceived curving caused by drift.

To provide a comparison measure, a consumer-grade hand-held GPS unit was used to measure ground truth. Because position data from such a GPS is quite noisy, the GPS data was manually smoothed and missing data points resulting from occasional GPS outages were filled. The smoothed ground truth data was used to compute the momentary heading error at each footfall, as well as the average heading error for each complete walk.

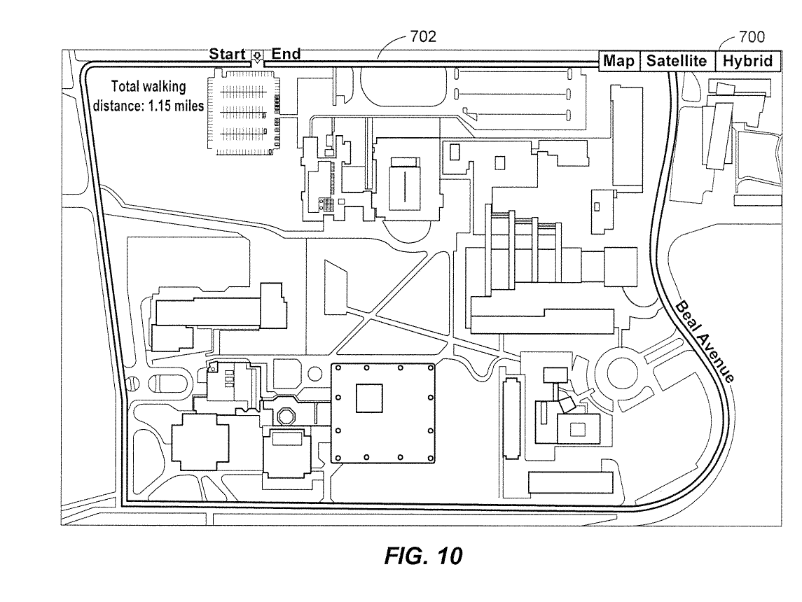

The test was run multiple times. FIG. 11 illustrates one of the test walks taken along path 702. As a reference point, GPS position data 800 is plotted, as is the uncorrected position data 802 from a personal dead reckoning system that did not use an HDR technique. Position data that has been corrected using HDR is shown at plot 804 and shows a vast improvement in heading and positional data.

| | E_{Ψ} | E_{Ψ} | E_{Ψ} | E_{Ψ} | E_{Ψ} | |
|---|---|---|---|---|---|---|
| | final | average | final | average | final | E_{Ψ} average |
| Mode | [deg] | [deg] | [deg] | [deg] | [deg] | [deg] |
| | Walk 1 | | Walk 2 | | Walk 3 | |
| Uncorrected | 165 | 68 | 307 | 145 | 124 | 49 |
| HDR- | 25 | 13 | 4 | 10 | 25 | 7.7 |
| corrected | | | | | | |
| Relative HDR | 6.6x | 5.1x | 77x | 14x | 5.0x | 6.4x |
| improvement | | | | | | |
| | Walk 4 | | Walk 5 | | Average of 5 Walks | |
| Uncorrected | 102 | 34 | 288 | 131 | 197 | 85 |
| HDR- | 30 | 15 | 20 | 15 | 21 | 12 |
| corrected | | | | | | |
| Relative HDR | 3.4x | 2.3x | 14x | 8.9x | 9.4x | 7.1x |
| improvement | | | | | | |

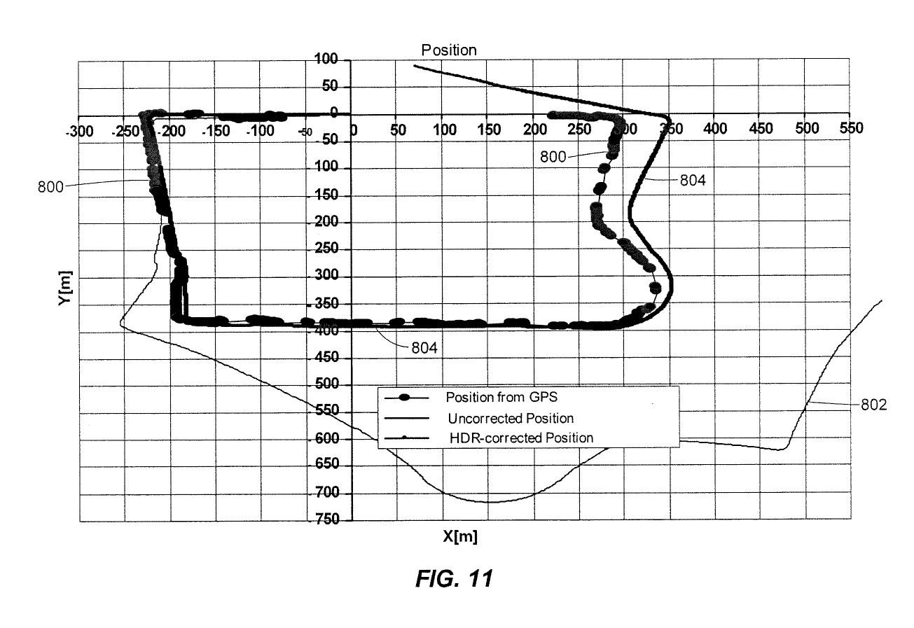

The Table above shows that a seven-fold improvement in the average heading error was attained and an almost 10-fold improvement in the final heading error was attained. These improvements are illustrated by way of example, and not limitation, but clearly show a marked improvement from an HDR enabled system. In these tests, an example HDR system having adaptive gain control and a double low pass filter were used. FIG. 12 illustrates an aerial, satellite view of layout 900 used for testing an HDE system in accordance with the foregoing. The layout 900 is that of a portion of the North Campus at the University of Michigan, in Ann Arbor, Mich. A test person having an HDE equipped personal tracking device walked along path 902 across the layout 900. This path started an the Start point in a building labeled CSE, then passed through a building labeled DOW, a building labeled GGB, a building labeled EECS, a building labeled the Autolab, a building labeled Duderstadt, and then to a building labeled Pierpoint. Once in the Pierpoint building, the user turned around and walked back that entire path to the End point back in the CSE building. The entire walk was approximately 1-hour in length and the total walking distance was 3,900 m (2.4 miles). Using an HDE system, the average heading error was 1.8°. The final position error measured by the HDE tracking device at the Start/End point was 8.20 m, which was only 0.2% of the total travel distance. The HDE system was extremely effective in reducing heading errors and accurately indicating positional data as a result. For indoor walks, the HDE system can reduce heading and, consequently, position errors by one to two orders of magnitude.

Examples above are discussed in terms of gyroscope-based sensor devices. However, the HDR and HDE techniques may be used with other sensor devices capable of computing heading directions, rates of rotation, and even position. Gyroscope devices are merely an example of the type of sensors that can be corrected for effectively. Extending beyond gyroscopes, slow-vary drift also appears in many of these other sensor-type applications. For example, remote controlled vehicles may use odometry to compute heading, more specifically with wheel encoders. Odometry produces slowly-varying errors that are similar to those of gyros, although the causes between the two sensor types are entirely different. HDR and HDE can both be applied to correcting heading errors resulting from these odometry devices, so long as the heuristic assumptions are applicable. This can be readily understood in that the processes described above are based on the measured output value, for example, the rate of rotation, which output value can be produced by any suitable sensor type.

The HDE techniques described herein may be applied whenever there are discrete directions or positions in which motion occurs, beyond just dominant directions. For example, the HDE technique was applied in an application that estimated the vertical location of a walker within a building (i.e., the floor number). Vertical location is normally computed by a combination of gyros and accelerometers. However, due to drift in these sensors, errors in the Z-axis (i.e., the vertical location) can grow without bound. For example, after 10-20 minutes the Z-axis errors may become too large to determine unambiguously which building floor the walker is on. If floor heights are known, then a heuristic assumption may be made that the user is on one of the floors, each of which has a known Z-coordinate.

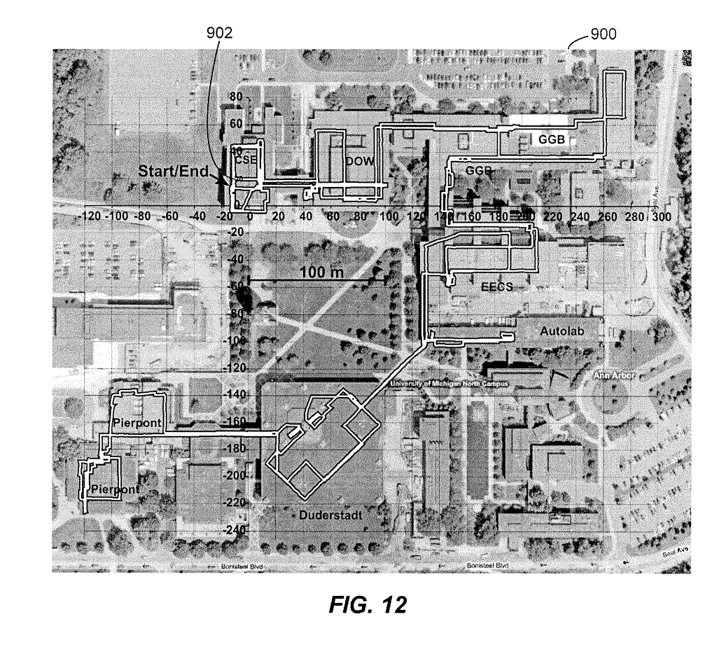

These known Z-coordinates are in essence like dominant directions, and are thus termed dominant Z-coordinates. If increments A between dominant Z-coordinates are constant, as might be the case when dominant Z-coordinates describe the height of the floors of a building, the MOD function can be used in the same way as with dominant directions, except that now its arguments are MOD(H, Δ), where H is the estimated height and Δ is the increment between consecutive floors. FIG. 13 shows modified closed loop control system that implements the HDE approach for estimating Z-coordinates in buildings. The HDE systems using dominant Z-coordinates may collect Z-axis data from one or more sensors. Different sensors can be used to estimate the Z-coordinate. For example, an IMU mounted on a walking person is one such sensor. Another commonly used sensor for measuring elevation is a so-called barometric altimeter, as shown. This sensor measures current air pressure which decreases with altitude. Barometric pressure changes over time as a function of weather conditions. These changes are relatively slow and act therefore similar to drift in gyros. Regardless of what kind of sensor supplies the data, the HDE system of FIG. 13 may apply that data to a MOD function controller 900 that determines the closest, discrete Z-axis position that corresponds to the measured Z-axis data.

This comparison of the MOD controller 900 may be made by one of the above MOD controllers, for example, by having that controller concurrently operate on both the Z-axis data and the optimizations already discussed above. Alternatively, a separate dedicated Z-axis MOD controller may be used. In either case, a Z-axis MOD controller is able to apply a heuristic assumption that only discrete Z-axis positions can be output from a tracking device and if any such positions are not being provided then the system will remove the error and produce one of the corrected Z-axis values. When going up/down stairs or elevators, the measured Z-axis values will change dramatically and quickly, similar to curving or turning as described above. Therefore, the HDE system may be programmed such that the Z-axis MOD controller is turned off or attenuated in its correction control under such conditions, using similar techniques to those described above with respect to HDR and HDE systems.

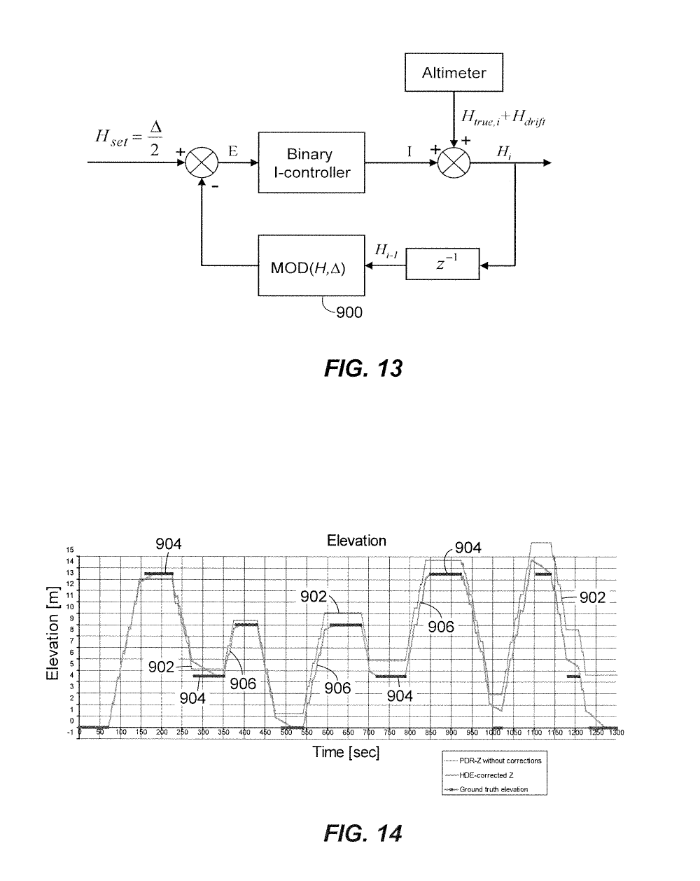

FIG. 14 illustrates a plot of elevation versus time for a walk up and down the stairs and along the corridors of a 4-story building. An HDE technique was applied to “nudge” the computed Z coordinate toward the known dominant Z-values that represent the floors. Curves are shown for the z-axis date from a personal dead reckoning system without correction (902), the true ground elevation value (904), and the HDE-corrected z values (906).

At least some of the various blocks, operations, and techniques described above may be implemented in hardware, firmware, software, or any combination of hardware, firmware, and/or software. When implemented in software or firmware, the software or firmware may be stored in any computer readable memory such as on a magnetic disk, an optical disk, or other storage medium, in a RAM or ROM or flash memory, processor, hard disk drive, optical disk drive, tape drive, etc. Likewise, the software or firmware may be delivered to a user or a system via any known or desired delivery method including, for example, on a computer readable disk or other transportable computer storage mechanism or via communication media. Communication media typically embodies computer readable instructions, data structures, program modules or other data in a modulated data signal such as a carrier wave or other transport mechanism. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Thus, the software or firmware may be delivered to a user or a system via a communication channel such as a telephone line, a DSL line, a cable television line, a fiber optics line, a wireless communication channel, the Internet, etc. (which are viewed as being the same as or interchangeable with providing such software via a transportable storage medium). The software or firmware may include machine readable instructions, also described as computer-executable instructions, that are capable of causing one or more controllers (computers, processors, etc.) to perform various acts, such as the processes described herein.

While the present invention has been described with reference to specific examples, which are intended to be illustrative only and not to be limiting of the invention, it will be apparent to those of ordinary skill in the art that changes, additions and/or deletions may be made to the disclosed embodiments without departing from the spirit and scope of the invention.

The foregoing description is given for clearness of understanding only, and no unnecessary limitations should be understood therefrom, as modifications within the scope of the invention may be apparent to those having ordinary skill in the art.

What is claimed is:

1. A method for removing drift error from a tracking device having a sensor assembly to measure rate of rotation and heading for the tracking device, the method comprising:
removing static drift error from the measured rate of rotation to produce a normalized rate of rotation, wherein the normalized rate of rotation includes a drift error component that varies during operation of the tracking device;
applying the normalized rate of rotation to a closed loop feedback control that includes an accumulator for accumulating error values corresponding to a difference between the normalized rate of rotation and a baseline rate of rotation;
the closed loop feedback control producing an integrator signal that counteracts the effects of the drift error component of the normalized rate of rotation; and
correcting the normalized rate of rotation by applying the integrator signal to the normalized rate of rotation signal to produce a corrected rate of rotation signal.

2. The method of claim 1, wherein the baseline rate of rotation is set to zero.

3. The method of claim 1, further comprising determining the static drift error by measuring the static drift error at an initial non-moving state of the tracking device.

4. The method of claim 1, further comprising supplying the normalized rate of rotation and the baseline rate of rotation to a comparator that produces a feedback loop error signal and supplying that feedback loop error signal to the accumulator, wherein the accumulator accumulates the error to produce the integrator signal.

5. The method of claim 4, further comprising determining whether the feedback loop error signal represents a positive drift error or a negative drift error, and if a positive drive error increasing the integrator signal by an increment amount, and if a negative drive error decreasing the integrator signal by the increment amount.

6. The method of claim 5, further comprising adjusting the magnitude of the increment amount.

7. The method of claim 6, wherein the normalized rate of rotation are either positive indicating a first turn type or negative indicating a second turn type, the method further comprising adjusting the magnitude of the increment amount in response to the length of time that consecutive normalized rates of rotation from the tracking device have the same sign, either positive or negative.

8. The method of claim 7, further comprising reducing the increment amount when a threshold number of consecutive normalized rates of rotation have the same sign, either positive or negative.

9. The method of claim 6, further comprising adjusting the increment amount in a manner inversely proportional to the magnitude of the normalized rate of rotation.

10. The method of claim 1, further comprising applying a low pass filtering to the normalized rate of rotation before supplying the normalized rate of rotation to the closed loop feedback control.

11. The method of claim 1, further comprising applying a double low pass filtering to the normalized rate of rotation before supplying the normalized rate of rotation to the closed loop feedback control.

12. The method of claim 11, further comprising applying a delagging process to the corrected rate of rotation.

13. The method of claim 1, wherein the sensor is a gyroscopic device.

14. The method of claim 1, wherein the tracking device is a personal dead reckoning system.

15. The method of claim 1, wherein the tracking device is a vehicle tracking device.

16. A method for removing drift error from a tracking device having a sensor assembly to measure rate of rotation and heading for the tracking device, the method comprising:
removing static drift error from the measured rate of rotation to produce a normalized rate of rotation, wherein the normalized rate of rotation includes a drift error component that varies during operation of the tracking device;
integrating the normalized rate of rotation to produce a feedback heading;
supplying the feedback heading to a closed loop feedback control that is to perform a low pass filtering on the feedback heading and that is to map the feedback heading onto one of a plurality of dominant directions to form a mapped feedback heading;
an accumulator within the closed loop feedback control accumulating error values corresponding to a difference between the mapped feedback heading and a baseline heading;
the closed loop feedback control producing an integrator signal that counteracts the effects of the drift error component of the normalized rate of rotation;
correcting the normalized rate of rotation by applying the integrator signal to the normalized rate of rotation signal to produce a corrected rate of rotation signal; and
integrating the corrected rate of rotation to produce a corrected heading.

17. The method of claim 16, wherein the baseline heading is set to a value between at least two of the plurality of dominant directions.

18. The method of claim 17, further comprising mapping the feedback heading onto one of the plurality of dominant directions by supplying the feedback heading to a controller that performs a MOD function on the feedback heading, where the MOD function is expressed as:
MOD(ψ,Δ)=ψ−ΔINT(ψ/Δ)
where ψ is one of the plurality of dominant directions and Δ is the baseline heading, and wherein INT(ψ/Δ) is a function that rounds ψ/Δ down to the nearest integer.

19. The method of claim 16, further comprising determining the static drift error by measuring the static drift error at an initial non-moving state of the tracking device.

20. The method of claim 16, further comprising:
supplying the mapped feedback heading and the baseline heading to a comparator that produces a feedback loop error signal; and
supplying that feedback loop error signal to the accumulator, wherein the accumulator accumulates the error signal to produce the integrator signal.

21. The method of claim 20, further comprising determining whether the feedback loop error signal represents a positive drift error or a negative drift error, and if a positive drift error increasing the integrator signal by an increment amount, and if a negative drive error decreasing the integrator signal by the increment amount.

22. The method of claim 16, wherein the sensor is a gyroscopic device.

23. The method of claim 16, wherein the tracking device is a personal dead reckoning system.

24. The method of claim 16, wherein the tracking device is a vehicle tracking device.

25. A tracking device comprising:
a sensor assembly to measure rate of rotation and heading for the tracking device;
a memory for storing measured rate of rotation and heading data; and
a controller to execute computer-executable instructions for,
removing static drift error from the measured rate of rotation to produce a normalized rate of rotation, wherein the normalized rate of rotation includes a drift error component that varies during operation of the tracking device;
integrating the normalized rate of rotation to produce a feedback heading;
supplying the feedback heading to a closed loop feedback control that is to perform a low pass filtering on the feedback heading and that is to map the feedback heading onto one of a plurality of dominant directions to form a mapped feedback heading;
an accumulator within the closed loop feedback control accumulating error values corresponding to a difference between the mapped feedback heading and a baseline heading;
the closed loop feedback control producing an integrator signal that counteracts the effects of the drift error component of the normalized rate of rotation;
correcting the normalized rate of rotation by applying the integrator signal to the normalized rate of rotation signal to produce a corrected rate of rotation signal; and
integrating the corrected rate of rotation to produce a corrected heading.

26. The apparatus of claim 25, wherein the controller is to execute computer-executable instructions such that the baseline heading is set to a value between at least two of the plurality of dominant directions.

27. The apparatus of claim 25, wherein the controller is to execute computer-executable instructions for mapping the feedback heading onto one of the plurality of dominant directions by performing a MOD function on the feedback heading, where the MOD function is expressed as:
MOD(ψ,Δ)=ψ−ΔINT(ψ/Δ)
where ψ is one of the plurality of dominant directions and Δ is the baseline heading, and wherein INT(ψ/Δ) is a function that rounds ψ/Δ down to the nearest integer.

28. The apparatus of claim 25, wherein the controller is to execute computer-executable instructions for determining the static drift error by measuring the static drift error at an initial non-moving state of the tracking device.

29. The apparatus of claim 25, wherein the controller is to execute computer-executable instructions for:
supplying the mapped feedback heading and the baseline heading to a comparator that produces a feedback loop error signal; and
supplying that feedback loop error signal to the accumulator, wherein the accumulator accumulates the error signal to produce the integrator signal.

30. The apparatus of claim 29, wherein the controller is to execute computer-executable instructions for determining whether the feedback loop error signal represents a positive drift error or a negative drift error, and if a positive drift error increasing the integrator signal by an increment amount, and if a negative drive error decreasing the integrator signal by the increment amount.

31. The apparatus of claim 25, further comprising an inertial measurement unit containing the sensor, and wherein the sensor is a gyroscopic device.

32. The apparatus of claim 25, wherein the tracking device is a personal dead reckoning system.

33. The apparatus of claim 25, wherein the tracking device is a vehicle tracking device.

34. A tracking device comprising:
a sensor assembly to measure rate of rotation and heading for the tracking device;
a memory for storing measured rate of rotation and heading data; and
a controller to execute computer-executable instructions for,
removing static drift error from the measured rate of rotation to produce a normalized rate of rotation, wherein the normalized rate of rotation includes a drift error component that varies during operation of the tracking device;
applying the normalized rate of rotation to a closed loop feedback control that includes an accumulator for accumulating error values corresponding to a difference between the normalized rate of rotation and a baseline rate of rotation;
the closed loop feedback control producing an integrator signal that counteracts the effects of the drift error component of the normalized rate of rotation; and
correcting the normalized rate of rotation by applying the integrator signal to the normalized rate of rotation signal to produce a corrected rate of rotation signal.

35. The apparatus of claim 34, wherein the controller is to execute computer-executable instructions such that the baseline rate of rotation is set to zero.

36. The apparatus of claim 34, wherein the controller is to execute computer-executable instructions for determining the static drift error by measuring the static drift error at an initial non-moving state of the tracking device.

37. The apparatus of claim 34, wherein the controller is to execute computer-executable instructions for supplying the normalized rate of rotation and the baseline rate of rotation to a comparator that produces a feedback loop error signal and supplying that feedback loop error signal to the accumulator, wherein the accumulator accumulates the error to produce the integrator signal.

38. The apparatus of claim 37, wherein the controller is to execute computer-executable instructions for determining whether the feedback loop error signal represents a positive drift error or a negative drift error, and if a positive drive error increasing the integrator signal by an increment amount, and if a negative drive error decreasing the integrator signal by the increment amount.

39. The apparatus of claim 38, wherein the controller is to execute computer-executable instructions for adjusting the magnitude of the increment amount.

40. The apparatus of claim 39, wherein the normalized rate of rotation are either positive indicating a first turn type or negative indicating a second turn type, wherein the controller is to execute computer-executable instructions for adjusting the magnitude of the increment amount in response to the length of time that consecutive normalized rates of rotation from the tracking device have the same sign, either positive or negative.

41. The apparatus of claim 40, wherein the controller is to execute computer-executable instructions for reducing the increment amount when a threshold number of consecutive normalized rates of rotation have the same sign, either positive or negative.

42. The apparatus of claim 40, wherein the controller is to execute computer-executable instructions for adjusting the increment amount in a manner inversely proportional to the magnitude of the normalized rate of rotation.

43. The apparatus of claim 34, wherein the controller is to execute computer-executable instructions for applying a low pass filtering to the normalized rate of rotation before supplying the normalized rate of rotation to the closed loop feedback control.

44. The apparatus of claim 34, wherein the controller is to execute computer-executable instructions for applying a double low pass filtering to the normalized rate of rotation before supplying the normalized rate of rotation to the closed loop feedback control.

45. The apparatus of claim 34, wherein the controller is to execute computer-executable instructions for applying a delagging process to the corrected rate of rotation.

46. The apparatus of claim 34, further comprising an inertial measurement unit containing the sensor, and wherein the sensor is a gyroscopic device.

47. The apparatus of claim 34, wherein the tracking device is a personal dead reckoning system.

48. The apparatus of claim 34, wherein the tracking device is a vehicle tracking device.
